(19) United States
(12) Patent Application Publication
(10) Pub. No.: US 2006/0095477 A1
(43) Pub. Date: May 4, 2006

(54) Database synchronizing system and method

(75) Inventors: I-Ching Li, Shindian City (TW); Wen-Shu Lai, Shindian City (TW); Trsunyeng Yu, Shindian City (TW)

Correspondence Address: BIRCH STEWART KOLASCH & BIRCH, PO BOX 747, FALLS CHURCH, VA, 22040-0747, US

(73) Assignee: VIA TECHNOLOGIES, INC.

(21) Appl. No.: 11/119,767

(22) Filed: May 3, 2005

(30) Foreign Application Priority Data
Oct. 26, 2004 (TW) 093132451

(51) Int. Cl. G06F 17/30

(52) U.S. Cl. 707/200

(57) ABSTRACT

A database synchronizing system comprises a first subsystem and several second subsystems. The first subsystem comprises a first database. Each of the second subsystems comprises a second database, a data retrieving module, and a data merging module. The data retrieving module executes an updating request procedure to receive the data in the first database from the first subsystem. The data merging module synchronizes the data in the first database and the second databases with a merging method. The merging method comprises an inserting step, a deleting step, and an updating step.

### BACKGROUND OF THE INVENTION

1. Field of Invention

The invention relates to a database synchronizing system and method and, in particular, to a database synchronizing system and method that can synchronize the databases in multiple servers.

2. Related Art

The big-scale enterprise usually has huge organization, complex technology resources and variant products. To properly manage the information of the enterprise (such as the personnel matters, manufacturing equipments, research, financial affairs and the likes), it is necessary to build a database for immediately and exactly managing the above-mentioned important information. However, the enterprise may have many branches distributed at different locations all over the world across the limitations of ocean and land. The personnel matters, manufacturing equipments, research resources, and financial affairs in the branches usually contain different information. Furthermore, different branches may have databases of different specifications. These factors will make the instantaneous integration of information in the entire enterprise non-smoothly, and thus the staff member must do some extra works to get and integrate the data from different branches.

As shown in FIG. 1A, a user saves one set of data in three servers, including a first server 11, a second server 12 and a third server 13. When the user operates a user terminal 14 to update the data in the first server 11, he/she must login the second server 12 and the third server 13 for finding out the data to be updated and then updating the data therein. This method is not only miscellaneous to the user, but also increases the chance of mistakes. For example, if the user inputs wrong data in one database or does not update one server, the set of data that should be the same in all servers may record different content in different servers. Therefore, the conventional method of manually updating the data in multiple servers is inconvenient and not reliable. For solving this problem, a method of automatically updating the data in multiple servers is disclosed.

Referring to FIG. 1B, the user saves one set of data in a first server 11, a second server 12 and a third server 13, which construct a loop network. In this case, when one database is updated, the updated data are transferred in a clockwise direction or an anticlockwise direction of the loop network so as to update other databases. For example, when the user operates a user terminal 14 to update the data in the first server 11, the first server 11 will then transfer the updated data to the second server 12. After automatically updating the data in the second server 12, the second server 12 transfers the updated data to the third server 13. Then, the third server 13 transfers the updated data to the first server 11. Finally, the first server 11 can confirm that the updating procedures in all databases of the first server 11, second server 12 and third server 13 are completed.

The loop network server system mentioned above can update the data in multiple databases, but the user may not normally utilize the servers during the updating procedure. Regarding to the multiple servers, the updating procedures are taken place in the servers along the loop network one by one. This will waste lots of time for data transmission and data updating. The above-mentioned problems are more obvious when the servers are connected with each other by Internet. Therefore, the correction and instantaneous of the data in each server are affected. In addition, as the servers are connect with and transfer data to each other by Internet, the transmission errors or transmission interruptions always result in retransmissions of data. In this case, since the Internet transmission relates to many factors, the transmission errors or transmission interruptions may occur in any position. Thus, the user may not efficiently shrink the possible positions of error. For eliminating the error, information managing staffs in all branches must cooperate with each other to find out the bugs, the problem machines, and the wrong data. Therefore, the transmission errors can not be eliminated in a short time, which affects the total data updating time. Moreover, the transmission of the updated data can not be monitored efficiently in the loop network server system. Thus, the transmission problems between the servers can not be clearly handled, and the maintain of the whole system is difficult.

It is therefore an important subject of the invention to provide a database synchronizing system and method that can automatically synchronize data in the databases of multiple servers without affecting the user and monitor the updating procedures of the data in the databases of multiple servers.

### SUMMARY OF THE INVENTION

In view of the foregoing, the invention is to provide a database synchronizing system and a database synchronizing method that can automatically synchronize data in the databases of multiple servers without affecting the user and monitor the updating procedures of the data in the databases of multiple servers.

To achieve the above, a database synchronizing system of the invention includes a first subsystem and a plurality of second subsystems. In the invention, the first subsystem includes a first database, and each second subsystem comprises a second database, a data retrieving module, and a data merging module. The data retrieving module executes an updating request procedure to receive the data in the first database from the first subsystem. The data merging module synchronizes the data in the first database and the second databases with a merging method, which includes an inserting step, a deleting step and an updating step.

In addition, the invention discloses a database synchronizing method, which is cooperated with a first subsystem and a plurality of second subsystems. The first subsystem includes a first database, and each of the second databases includes a second database. The database synchronizing method includes the following steps of: executing an updating request procedure by each of the second subsystems for receiving data in the first database from the first subsystem; and synchronizing the data in the first database and data in the second database with a merging method. Herein, the merging method includes an inserting step, a deleting step and an updating step.

As mentioned above, the database synchronizing system and method of the invention process the data in the first and second databases with a merging method, so that the invention can automatically update the data in multiple databases without affecting the user. Furthermore, the invention can increase the instantaneity and correction of the data in each database. In addition, the database synchronizing system and method of the invention can efficiently monitor the data updating procedure of multiple servers. Thus, the data transmission between the servers can be controlled, so that the maintenance of the whole system becomes easier.

### BRIEF DESCRIPTION OF THE DRAWINGS

The invention will become more fully understood from the detailed description given herein below illustration only, and thus is not limitative of the present invention, and wherein:

FIG. 1A is a schematic view showing the conventional manually updating procedure;

FIG. 1B is a schematic view showing the conventional loop server system for updating data;

FIG. 2 is a schematic view showing a database synchronizing system according to a preferred embodiment of the invention;

FIG. 3 is a schematic view showing a database synchronizing system according to a preferred embodiment of the invention, which further includes a querying module;

FIG. 4 is a schematic view showing a database synchronizing system according to a preferred embodiment of the invention, which includes a user monitoring interface such as a window shown in a monitor;

FIG. 5 is a flow chart showing a database synchronizing method according to a preferred embodiment of the invention; and

FIG. 6 is a flow chart showing a database synchronizing method according to a preferred embodiment of the invention, which includes a step of determining whether the data in the second database is later than the data in the first database.

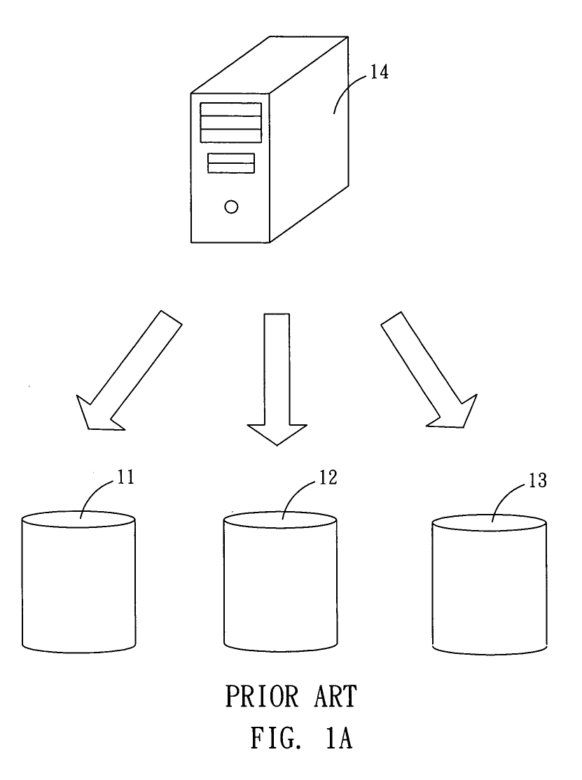

### DETAILED DESCRIPTION OF THE INVENTION

The present invention will be apparent from the following detailed description, which proceeds with reference to the accompanying drawings, wherein the same references relate to the same elements.

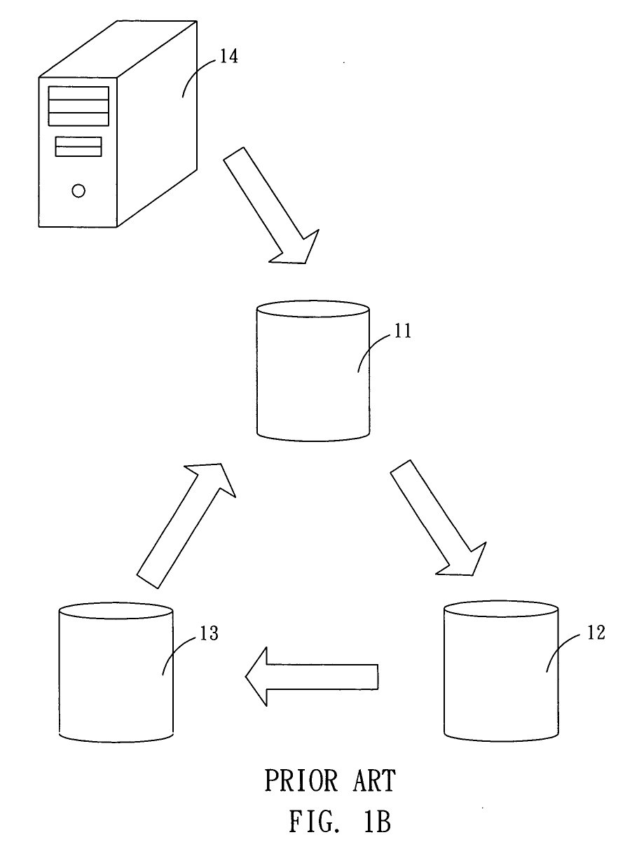

With reference to FIG. 2, a database synchronizing system according to a preferred embodiment of the invention includes a first subsystem 2 and a plurality of second subsystems 3. The first subsystem 2 includes a first database 21. Each second subsystem 3 includes a second database 31, a data retrieving module 32, and a data merging module 33.

The data retrieving module 32 executes an updating request procedure 321 to receive the data in the first database 21 from the first subsystem 2. Moreover, the first subsystem 2 may repeatedly execute the updating request procedure 321 after a predicted period.

The data merging module 33 synchronizes the data in the first database 21 and the data in the second databases 31 with a merging method. The merging method includes an inserting step, a deleting step and an updating step. When the second database 31 does not contain a set of first data 211 in the first database 21, the second database 31 will insert a set of second data 311 according to the first data 211. Otherwise, when the second database 31 contains a set of third data 312 that are not contained in the first database 21, the second database 31 will delete the third data 312. When the second database 31 contains a set of fourth data 313 corresponding to the first data 211, the second database 31 will update the fourth data 313 according to the first data 211.

In the present embodiment, the first subsystem 2 and second subsystems 3 are connected with each other by Internet. The second databases 31 can be heterogeneous databases. In the case that the second subsystems 3 and the first system 2 can not connect with each other according to the network connection problems, the data difference between the second databases 31 and the first database 21 generated during the non-connection period can be synchronized and integrated after the network connection of the second subsystems 3 and first subsystem 2 is recovered.

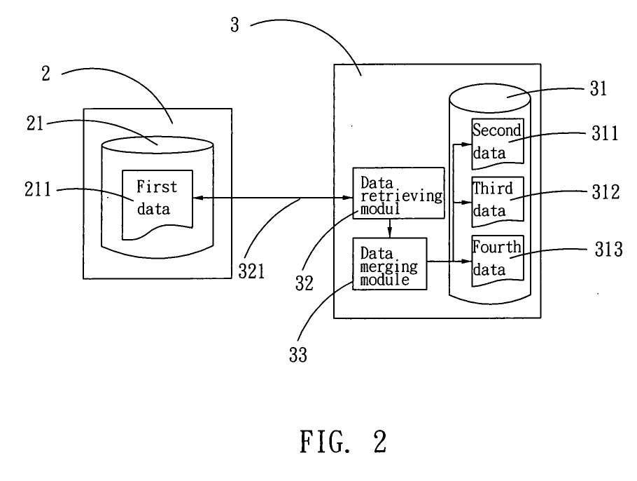

With reference to FIG. 3, the first subsystem 2 may further include a querying module 22 and a first record module 23, and the second subsystem 3 may further include a second record module 34.

The querying module 22 executes a querying procedure 221 to determine whether the data in the second database 31 are later than the data in the first database 21. In this embodiment, the querying procedure 221 is to compare the record updating time of the data modification. For example, the querying procedure 221 may compare the log files of the two databases such as the first database 21 and the second database 31. When the data in the second database 31 are later than the data in the first database 21, the newest data in the second database 31 are transferred to the other second databases (not shown) via the first subsystem 2. Since the above-mentioned comparison only involves the record updating time, the data in the first database 21 is unnecessary to be copied to the second database 31. In addition, the querying module 22 may repeatedly execute the querying procedure 221 after a predicted period.

The second record module 34 establishes an updating request log file 35 according to the updating request procedure 321. The first record module 23 establishes a querying log file 24 according to the querying procedure 221, and creates a user monitoring interface 25 according to the updating request procedure 321 and querying procedure 221. In this case, the user monitoring interface 25 can always response the system state of the embodiment. In addition, the first record module 23 may create the user monitoring interface 25 only according to the updating request procedure 321 or only according to the querying procedure 221.

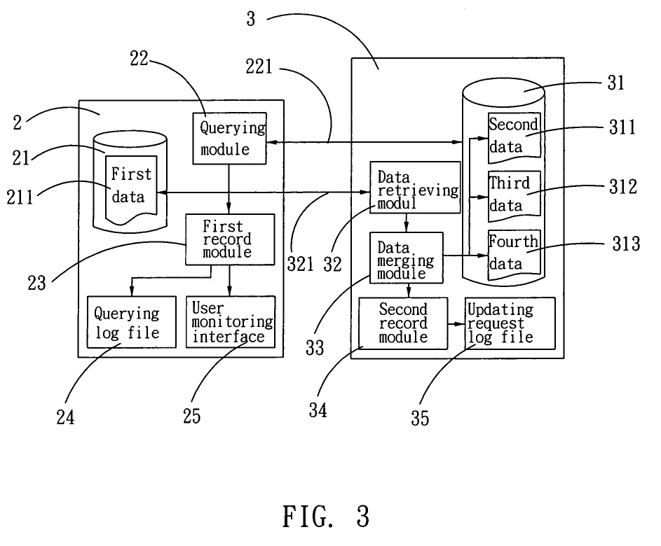

With reference to FIG. 4, the user monitoring interface 25 is a window shown in a monitor 4. The user monitoring interface 25 may further include the contents of the updating request log file 35 and querying log file 24. Accordingly, the user can recognize the system state of the embodiment based on the updating request log file 35, querying log file 24 and user monitoring interface 25. Therefore, when the system has problems, the user can quickly find out the bugs.

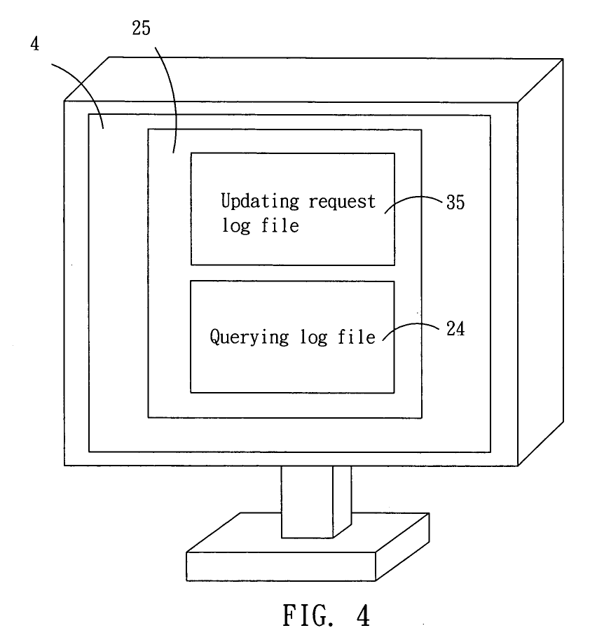

Referring to FIG. 5, a database synchronizing method according to a preferred embodiment is cooperated with a first subsystem and a plurality of second subsystems. In the embodiment, the first subsystem includes a first database and each second database includes a second database. The database synchronizing method includes the following steps S01 to S02.

In step S01, the second subsystem executes an updating request procedure for receiving data in the first database from the first subsystem.

In step S02, the data in the first database and data in the second database are synchronized with a merging method, which includes an inserting step, a deleting step and an updating step.

To be noted, the detailed procedures of the database synchronizing method of the embodiment are described previously with reference to FIG. 2, so the detailed descriptions are omitted here for concise purpose.

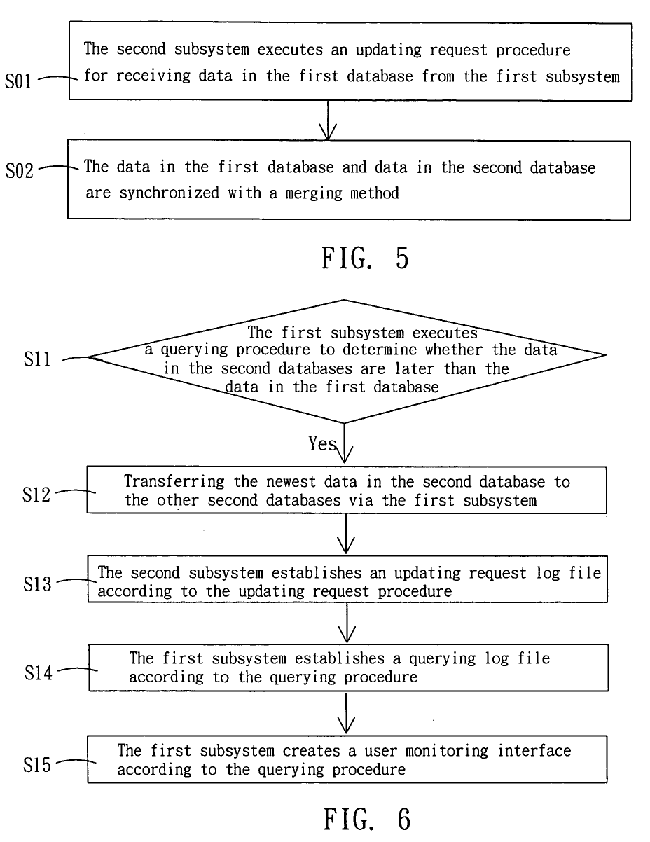

With reference to FIG. 6, the database synchronizing method of the embodiment may further include the following steps S11 to S15.

In step S11, the first subsystem executes a querying procedure to determine whether the data in the second databases are later than the data in the first database or not.

In step S12, when the data in one of the second database are later than the data in the first database, the newest data in the second database are transferred to the other second databases via the first subsystem.

In step S13, the second subsystem establishes an updating request log file according to the updating request procedure.

In step S14, the first subsystem establishes a querying log file according to the querying procedure.

In step S15, the first subsystem creates a user monitoring interface according to the querying procedure.

To be noted, the detailed procedures of the above-mentioned database synchronizing method of this embodiment are described previously with reference to FIGS. 3 and 4, so the detailed descriptions are omitted here for concise purpose.

In summary, the database synchronizing system and method of the invention process the data in the first and second databases with a merging method, so that the invention can automatically update the data in multiple databases without affecting the user. Furthermore, the invention can increase the instantaneity and correction of the data in each database. In addition, the database synchronizing system and method of the invention can efficiently monitor the data updating procedure of multiple servers. Thus, the data transmission between the servers can be controlled, so that the maintenance of the whole system becomes easier.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A database synchronizing method, which is cooperated with a first subsystem and a plurality of second subsystems, wherein the first subsystem comprises a first database and each of the second databases comprises a second database, the method comprising:
executing an updating request procedure by each of the second subsystems for receiving data in the first database from the first subsystem; and
synchronizing the data in the first database and data in the second database with a merging method, wherein the merging method comprises an inserting step, a deleting step and an updating step.

2. The method of claim 1, wherein the step of executing the updating request procedure by each of the second subsystems for receiving the data in the first database from the first subsystem further comprises:
repeatedly executing the updating request procedure after a predicted period by each of the second subsystems for receiving data in the first database from the first subsystem.

3. The method of claim 1, further comprising:
executing a querying procedure by the first subsystem to determine whether the data in each of the second databases are later than the data in the first database; and
when the data in one of the second database are later than the data in the first database, transferring the newest data in one of the second databases to the other second databases via the first subsystem.

4. The method of claim 3, wherein the step of executing the querying procedure by the first subsystem to determine whether the data in each of the second databases are later than the data in the first database further comprises:
repeatedly executing the querying procedure after a predicted period by the first subsystem to determine whether the data in each of the second databases are later than the data in the first database.

5. The method of claim 3, further comprising:
establishing a querying log file by the first subsystem according to the querying procedure.

6. The method of claim 3, further comprising:
creating a user monitoring interface by the first subsystem according to the querying procedure.

7. The method of claim 1, further comprising:
creating a user monitoring interface by the first subsystem according to the updating request procedure.

8. The method of claim 1, further comprising:
establishing an updating request log file by the second subsystem according to the updating request procedure.

9. The method of claim 1, wherein the first subsystem and the second subsystems are connected with each other by Internet.

10. The method of claim 1, wherein the second databases are heterogeneous databases.

11. A database synchronizing system, comprising:
a first subsystem, which comprises a first database; and
a plurality of second subsystems, wherein each of the second subsystems comprises a second database, a data retrieving module, and a data merging module, the data retrieving module executes an updating request procedure to receive the data in the first database from the first subsystem, the data merging module synchronizes the data in the first database and the second databases with a merging method, and the merging method comprises an inserting step, a deleting step and an updating step.

12. The system of claim 11, wherein each of the second subsystems repeatedly executes the updating request procedure after a predicted period for receiving data in the first database from the first subsystem.

13. The system of claim 11, wherein the first subsystem further comprises:
a querying module, which executes a querying procedure to determine whether the data in each of the second databases are later than the data in the first database, and when the data in one of the second database are later than the data in the first database, the newest data in one of the second database are transferred to the other second databases via the first subsystem.

14. The system of claim 13, wherein the first subsystem repeatedly executes the querying procedure after a predicted period to determine whether the data in each of the second databases are later than the data in the first database.

15. The system of claim 13, wherein the first subsystem further comprises:
a first record module, which establishes a querying log file according to the querying procedure.

16. The system of claim 13, wherein the first subsystem further comprises:
a first record module, which creates a user monitoring interface according to the querying procedure.

17. The system of claim 11, wherein the first subsystem further comprises:
a first record module, which creates a user monitoring interface according to the updating request procedure.

18. The system of claim 11, wherein each of the second subsystem further comprises:
a second record module, which establishes a updating request log file according to the updating request procedure.

19. The system of claim 11, wherein the first subsystem and the second subsystems are connected with each other by Internet.

20. The system of claim 11, wherein the second databases are heterogeneous databases.
